(19) United States
(12) Patent Application Publication
(10) Pub. No.: US 2009/0172908 A1
(43) Pub. Date: Jul. 9, 2009

(54) WIPER MECHANISM COMPRISING MEANS FOR LOCKING A DRIVE SHAFT IN AN ANGULAR POSITION

(75) Inventors: Yun Tang, Cernay La Ville (FR); Severin Bruneau, Rambouillet (FR); Franck Macaire, Antony (FR)

Correspondence Address: OSHA LIANG L.L.P., TWO HOUSTON CENTER, 909 FANNIN, SUITE 3500, HOUSTON, TX, 77010, US

(73) Assignee: Valeo Systemes d'Essuyage, La Verriere (FR)

(21) Appl. No.: 12/300,914

(22) PCT Filed: May 14, 2007
(86) PCT No.: PCT/EP07/54647

§ 371 Date: Nov. 14, 2008

(30) Foreign Application Priority Data
May 18, 2006 (FR) 0604439

(51) Int. Cl. B60S 1/04

(52) U.S. Cl. 15/250.16

(57) ABSTRACT

The invention relates to a wiper mechanism (18) for a window panel (12) which is pivotable relative to the body (16) of the vehicle (10) between a closed position, and between an open position in which the window panel (12), comprising a shaft (22) for driving a wiper arm (24) in rotation around a rotation axis relative to the window panel (12), a motor reducer (26) comprising a driving shaft (36) which is capable of being coupled in rotation with the drive shaft (22) when the window panel is in the closed position, and means for locking (40) the drive shaft (22) in rotation relative to the plate (20), in a predetermined angular position, characterized in that the locking means (4) include a locking member (42) which is mounted movably relative to the plate (20), between a position for locking the drive shaft (22) in rotation relative to the plate (20), and an unlocked position enabling the drive shaft (22) to rotate relative to the plate (20).

The invention provides a wiper mechanism of a window panel of a motor vehicle which is mounted to be pivoting with respect to the vehicle body, between an open position and a closed position.

The invention more particularly provides a wiper mechanism for a motor vehicle comprising a window panel which is mounted to be pivoting between a closed position and at least an open position. The wiper mechanism includes:
a plate for guiding in an alternate rotation a drive shaft about a main rotation axis;
a motor reducer which includes a motor shaft extending coaxially with the drive shaft, and
means for locking the drive shaft in rotation with respect to the plate in a predetermined angular position of the drive shaft.

The invention more particularly provides a wiper mechanism for a motor vehicle including a window panel which is mounted to be pivoting about an axis transversal with respect to a structural element of the vehicle body between a closed position, wherein the window panel substantially extends in a vertical and transversal plane, and at least an open position, wherein the window panel is inclined with respect to said vertical and transversal plane, the wiper mechanism including a plate for guiding in an alternate rotation a drive shaft of a wiper arm with respect to the window panel about a main rotation axis, which is fixed in an opening of the window panel, so that the main rotation axis is longitudinally oriented when the window panel is in the closed position, a motor reducer which is fixed to the structural element of the body and which includes a motor shaft extending coaxially with the drive shaft, when the window panel is in the closed position, and which is capable of being coupled in rotation with the drive shaft when the window panel is in the closed position, and means for locking the drive shaft in rotation with respect to the plate in a predetermined angular position of the drive shaft when the window panel is in the open position.

The window panel is generally mounted at the back of the vehicle, and the articulation thereof with respect to a structural element of the vehicle body makes it possible to pivot the window panel with respect to the vehicle body, so as to allow the clearing of an opening at the back of the vehicle, independently of the rear hatch of the vehicle, so as to give an access or at least a partial access to the internal volume of the vehicle.

A wiper mechanism is generally associated with this window panel, for cleaning the external face thereof.

Because the window panel is movable, it has been proposed to mount the assembly of the wiper mechanism on the window panel, so that the wiper mechanism is integral with the window panel to be pivoting with respect to the vehicle body.

However, the wiper mechanism more particularly includes a motor reducer which is a relatively bulky and relatively heavy element, which can notably hinder the opening of the window panel.

In order to face this problem, it has been proposed to make the wiper mechanism of several parts, i.e. a first part including the wiper arm which is mounted to be pivoting on the window panel through a guiding plate, and a second part including the drive motor reducer, which is mounted on a structural element of the vehicle body.

The wiper mechanism also includes means making it possible to couple the wiper arm with the drive mechanism when the window panel is closed, such as for example a coupling cylindrical sleeve.

Document FR-A-2,851,975 describes such a wiper mechanism which further includes means for locking the wiper arm in a specific position with respect to the window panel.

Such a locking makes it possible to prevent any angular shift of the wiper arm with respect to the drive mechanism thereof, when a user pivots the window panel.

According to this document, the locking of the drive arm is carried out through a radial finger which is integral with the coupling sleeve, and which is capable of being received in an associated groove provided in the guiding plate in rotation of the wiper arm.

In addition, the sleeve is mounted to be axially sliding with respect to the plate in order to allow the motion of the locking finger out of the associated groove, in order to enable the pivoting of the wiper arm, when the window panel is in the closed position.

Thus, to allow the axial sliding of the coupling sleeve, the plate includes a guiding stem which has relatively important axial dimensions.

Consequently, the overall dimensions of the plate are important, which affects the global aesthetic appearance of the vehicle.

The aim of the invention consists in proposing a wiper mechanism including means for angularly locking the drive arm for which the coupling sleeve is axially stationary with respect to the plate, which limits the axial overall dimensions of the support plate.

For this purpose, the invention provides a wiper mechanism of the previously described type, characterised in that the locking means include a locking member which is mounted to be movable with respect to the plate between a locking position, wherein the locking member cooperates with the drive shaft to lock the drive shaft in rotation with respect to the plate when the window panel is in the open position, and an unlocking position wherein the locking member does not cooperate with the drive shaft, thus allowing the rotation of the drive shaft with respect to the plate when the window panel is in the closed position.

According to other characteristics of the invention:
the drive shaft carries a coupling sleeve for coupling the drive shaft with the motor shaft in rotation with respect to the plate which is integral with the drive shaft during the motion of the window panel with respect to the structural element of the vehicle body, and the locking member is capable of cooperating with the drive shaft through the sleeve in order to obtain the locking of the drive shaft in rotation with respect to the plate;
the locking member is mounted to be slidingly movable with respect to the plate according to a direction substantially parallel to the main axis of the drive shaft between a front locking position and a rear unlocking position;
the sleeve includes a radial finger which is capable of abutting against an axial rod associated with the locking member;
the locking member includes a locking clamp which is movable substantially radially with respect to the main axis of the drive shaft and which is capable of cooperating with the sleeve for locking the drive shaft;
the locking member includes an arm which is mounted to be pivoting with respect to the plate about an axis perpendicular to the main axis of the drive shaft, and which also holds the locking clamp;
the plate includes elastic return means for returning the locking member towards the locking position thereof, and the locking member is capable of cooperating with a bearing element which is mounted on the structural element of the body, so that a motion of the window panel towards the closed position thereof results in the bearing of the locking member against the bearing element, then the motion of the locking member with respect to the plate to the unlocking position thereof, against the return elastic force;
the bearing element is a component of the motor reducer which is fixed to the structural element of the body;
the bearing element consists of a coaxial disk for the motor shaft which is integral with the motor shaft rotating with respect to the structural element of the body;
the predetermined angular position is an extreme angular position of the drive shaft corresponding to a rest position of the wiper mechanism;
the drive shaft includes a crankshaft pin and the locking member includes a mechanical stop which is mounted to be slidingly movable with respect to the plate according to a direction substantially parallel to the main axis of the drive shaft between a locking position, wherein the mechanical stop is in contact with the crankshaft pin to obtain the locking in rotation of the drive shaft, and an unlocking position; and
the mechanical stop and the crankshaft pin have matching shapes.

Other characteristics and advantages of the invention will appear upon reading the following detailed description for the understanding of which reference will be made to the appended Figures, among which:

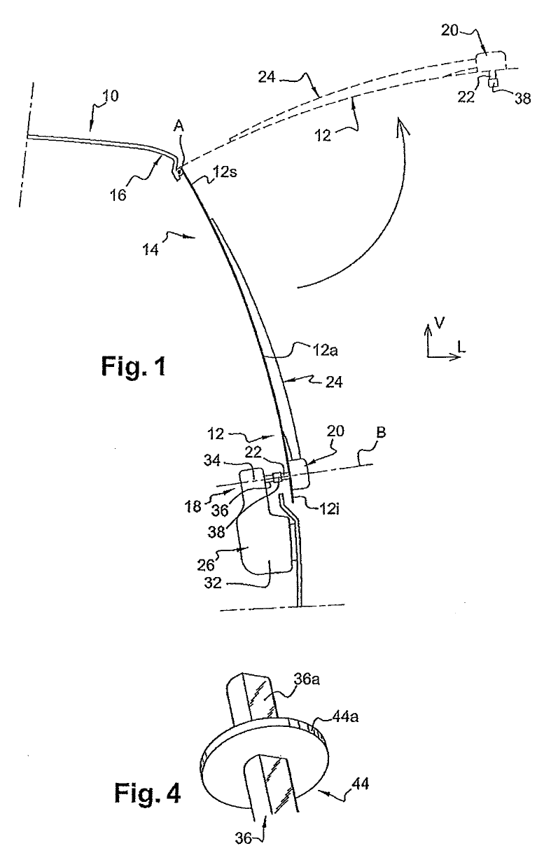

FIG. 1 is a schematic cross-sectional diagram along a longitudinal and vertical plane of the rear part of a motor vehicle, showing a movable window panel pivoting with respect to the body of the vehicle, and including a mechanism for wiping the window panel composed of two parts, and means for coupling one part with the other;

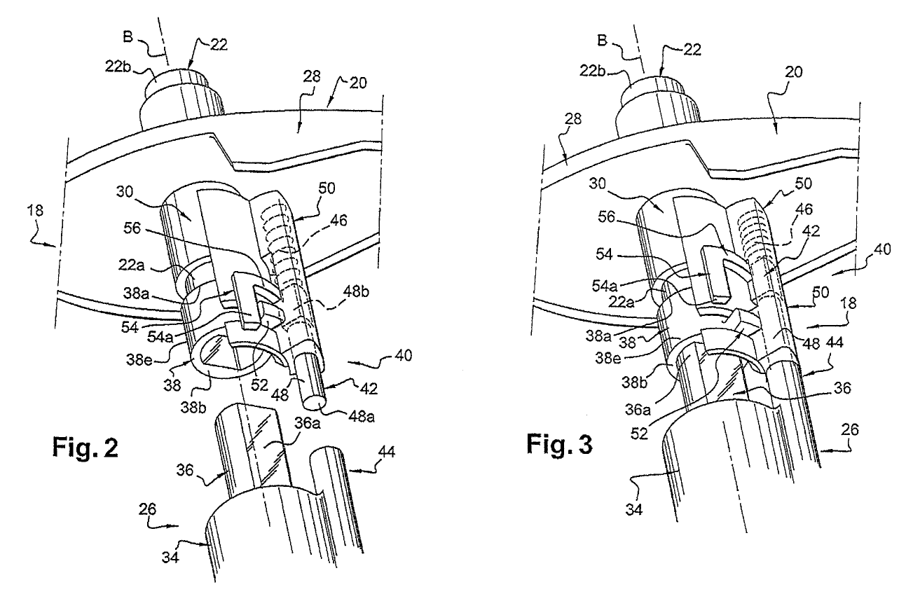

FIG. 2 is a perspective schematic representation, on a bigger scale, of the means for coupling the wiper mechanism shown in FIG. 1, wherein the coupling means are shown in a position, wherein the drive shaft is locked when the window panel is in an open position;

FIG. 3 is a view similar to that of FIG. 2, wherein the coupling means are shown in the drive shaft unlocking position when the window panel is in the closed position;

FIG. 4 is an alternative embodiment of the member actuating the locking means which are mounted on the motor reducer output shaft;

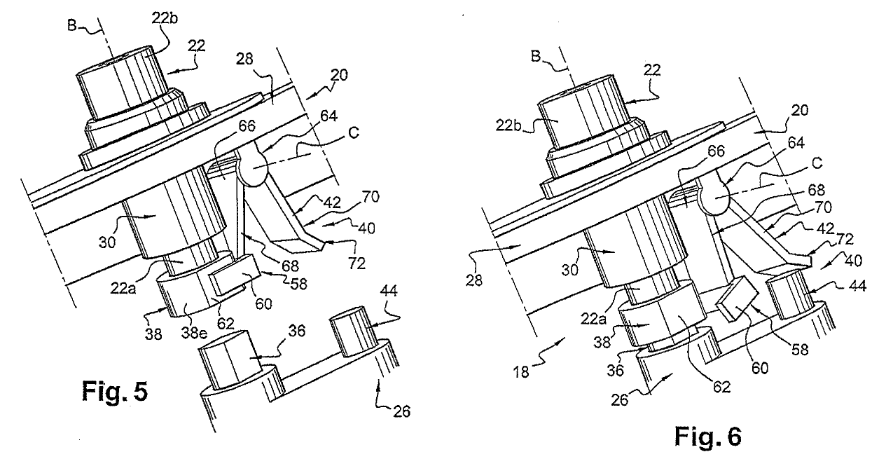

FIG. 5 is a perspective schematic representation of the first part of the wiper mechanism, which is mounted on the window panel, showing a variation of the making of the locking means which include a movable locking member which is mounted to be hinged with respect to the guiding plate, and wherein the locking means are shown in the drive shaft locking position when the window panel is in an open position;

FIG. 6 is a view similar to that of FIG. 5, wherein the locking means are shown in the drive shaft unlocking position, when the window panel is in the closed position;

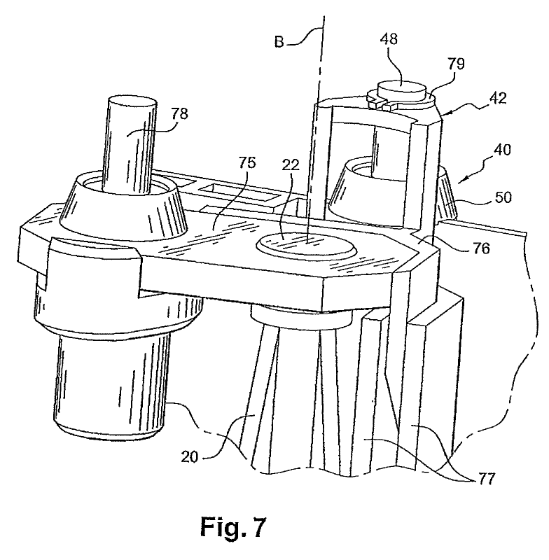

FIG. 7 is a perspective schematic representation of an alternative solution.

FIG. 1 shows the rear part of a motor vehicle 10 which includes a window panel 12 which closes an opening 14 made in a structural element of the body 16 of the vehicle 10.

The window panel 12 is mounted to be pivoting around a transversal axis A with respect to the structural element of the body 16, between a lower closing position of the opening 14, in which the window panel 12 extends in a substantially vertical and transversal plane, and an upper opening position shown in dotted lines, wherein the window panel 12 is inclined with respect to the vertical and transversal plane, so as to give access to the internal volume of the vehicle 10.

The vehicle 10 also includes a wiper mechanism 18 of the rear external face 12a of the window panel 12, which is arranged here at the level of the transversal edge of the lower end 12i of the window panel 12.

The wiper mechanism 18 includes a plate 20 for guiding in rotation about a main rotation axis B a drive shaft 22 of a wiper arm 24 in an alternate scanning motion about the main rotation axis B, and a motor reducer 26 which is mounted on the structural element of the body 16 of the vehicle 10.

As can be seen in greater details in FIGS. 2 and 3, the guiding plate 20 includes a body 28 for mounting the plate 20 on the window panel 12 and a stem 30 for guiding in rotation the drive shaft 22, which passes through a matching orifice of the window panel 12, so that the drive shaft 22 includes a front end 22a which extends in front of the window panel 12, and a rear end 22b which extends behind the window panel 12.

The plate 20 is made so that the main rotation axis B is oriented substantially longitudinally when the window panel 12 is in the closed position thereof, as can be seen more particularly in FIG. 1, which means substantially perpendicularly to the main plane of the window panel 12.

The motor reducer 26 is of a known type and it includes a motor 32 and a reducer 34 which makes it possible to transform the continuous rotating motion of the motor output shaft 32 into an alternate rotating motion of a motor shaft 36.

The motor reducer 26 is fixed to the structural element of the body, so that the motor shaft 36 is longitudinally and coaxially oriented with respect to the drive shaft 22, when the window panel 12 is in the closed position, as can be seen in FIG. 3.

The plate 20 and the drive shaft 22 are integral with the window panel 12 rotating about the transversal axis A with respect to the structural element of the body 16.

Consequently, the drive shaft 22 is capable of separating from the motor shaft 36, when the window panel 12 is not in the closed position thereof.

The wiper mechanism 18 also includes a sleeve 38 which makes it possible to obtain a coupling in rotation of the drive shaft 22 with the motor shaft 36 in rotation about the main rotation axis B, when the window panel 12 is in the closed position.

The sleeve 38 is a substantially cylindrical element which extends coaxially with the drive shaft 22, one rear end 38a of which is connected to the drive shaft 22, and a front end 38b of which is capable of being connected to the motor shaft 36.

The sleeve 38 defines an internal recess having a non-circular, in this case oblong, section wherein the front axial end 22a of the drive shaft 22 is received, and wherein the rear end 36a of the motor shaft 36 is received when the window panel 12 is in the lower closing position thereof.

In addition, the rear end 36a of the motor shaft 36 and the front end 22a of the drive shaft 22 have a section matching the section of the recess defined by the sleeve 38.

The motor shaft 36 and the drive shaft 22 are thus received in the sleeve 38 without any clearance, the alternate rotation motion of the motor shaft 36 about the main rotation axis B can thus be transmitted to the drive shaft 22 without any interfering vibration.

The wiper mechanism 18 also includes means 40 for locking the drive shaft 22 in rotation about the main axis B with respect to the plate 20, when the window panel 12 is in the open position, as shown in FIG. 2.

According to the invention, the locking means 40 include a locking member 42 which is mounted to be movable with respect to the plate 20, and which is capable of cooperating with the sleeve 38, so as to lock the drive shaft 22 in rotation.

The locking member 42 is mounted to be movable with respect to the plate 20 between a locking position shown in FIG. 2, wherein it cooperates with the sleeve 38, when the window panel 12 is in an open position, and an unlocking position shown in FIG. 3 wherein the locking member 42 does not cooperate with the sleeve 38, when the window panel 12 is in the closed position.

The locking member 42 is made so that, when it cooperates with the sleeve 48, it prevents the sleeve 38, and thus the drive shaft 22, from pivoting about the principal rotation axis B. Thus, the wiper arm 24 is maintained in the same position with respect to the window panel 12, when the window panel 12 is in an open position.

According to a preferred embodiment of the invention, the locking member 42 is driven towards the locking position thereof, as shown in FIG. 3 through a bearing element 44 which is integral with the motor reducer 26, and it is driven towards the locking position thereof, as shown in FIG. 2 through a return elastic element which consists of a helical spring 46.

Thus, when the window panel 12 is moved from an open position to a closed position thereof, the locking member 42 comes to bear against the bearing element 44 when the window panel 12 is in a position close to the closed position thereof.

Then, when the window panel 12 is moved from this intermediate position towards the closed position thereof, as shown in FIG. 3, the locking element 42 is driven by the bearing element 44 into a motion with respect to the plate 20, towards the unlocking position thereof.

FIGS. 2 to 4 show a first embodiment of the invention, wherein the locking member 42 is mounted to be slidingly movable with respect to the plate 20 along a direction substantially parallel to the main axis B of the drive shaft 22, between a front position represented in FIG. 2, corresponding to the locking position thereof, i.e. wherein it cooperates with the sleeve 38, and a rear position shown in FIG. 3, corresponding to the unlocking position thereof, i.e. wherein it does not cooperate with the sleeve 38.

When the locking member 42 is driven in motion with respect to the plate 20 by the bearing element 44, against the return force exerted by the spring 46, the locking member is then stationary with respect to the bearing element 44, and slides substantially longitudinally backwards with respect to the plate 20.

The locking member 42 includes a cylindrical rod 48 having a main axis parallel to the main rotation axis B, which is accommodated in the matching recess 50 of the plate 20 to be slidingly guided, with the front end 48a of such rod 48 being capable of abutting against the bearing element 44 of the motor reducer 26 and the rear end 48b of the rod 48 is connected to the spring 46 for returning the locking member 42 to the locking position thereof.

The sleeve 38 includes a radial finger 52 which radially extends towards the outside from the external cylindrical face 38e of the sleeve 38, and which is capable of cooperating with the locking member 42 to obtain the locking in rotation of the drive shaft 22.

For this purpose, the locking member 42 includes an axial locking rod 54 which is angularly shifted with respect to the rod 48, about the main rotation axis B, and which is connected to the rod 48 through a transversal segment 56.

The axial rod 54 is longitudinally arranged with respect to the rod 48 so that, when the locking member 42 is in the front locking position thereof, the finger 52 of the sleeve 38 is received between the rod 48 and the axial rod 54.

Finally, the axial rod 54 is positioned axially with respect to the rod 48 so that, when the locking member 42 is in the front position thereof, the front axial end 54a of the axial rod 54 is positioned longitudinally, in front of the finger 52, and when the locking member 42 is in the rear position thereof, as shown in FIG. 3, the front axial end 54a of the axial rod 54 is positioned axially behind the finger 52, thus making the globally transversal motion of the finger 52 possible.

The axial rod 54 is arranged transversally, i.e. tangentially with respect to the rotation axis B, so that the finger 52 is capable of tangentially abutting leftwards, when looking at FIG. 2, against the axial rod 54 when the locking member 42 is in the locking position. In addition, the recess 50 of the rod 48 is provided so that the finger 52 of the sleeve 38 is capable of tangentially abutting rightwards, when looking at FIG. 2, against a face opposite the recess 50.

Thus, when the locking member 42 is in the locking position thereof, the finger 52 of the sleeve 38 cannot tangentially move with respect to the main rotation axis B. Consequently, the sleeve 38 and the drive shaft 22 cannot pivot about the main rotation axis B.

On the contrary, when the locking member 42 is in the unlocking position thereof, the finger 52 of the sleeve 38 can tangentially move rightwards with respect to the main rotation axis B, as can be seen in FIG. 3. Accordingly, the sleeve 38 and the drive shaft 22 are free to pivot with respect to the main axis B according to at least one direction.

According to a preferred embodiment, the locking means 40 are made so that the drive shaft 22 is locked in a predetermined angular position, which consists of a position about the main rotation axis B, which preferably corresponds to the rest position of the wiper mechanism 18.

Thus, when the finger 52 of the sleeve 38 is abutting against the face opposite the recess 50, the drive shaft 22 is in an angular position which matches such rest position of the wiper mechanism 18.

Now, FIG. 4 shows an alternative embodiment of the bearing element 44 which consists here of a disk which is mounted on the motor shaft 36 and the outer diameter of which is determined so that, when the window panel 12 is in the closed position thereof, the front end 48a of the rod 48 is bearing longitudinally frontwards against the rear radial face 44a of such disk 44.

FIGS. 5 and 6 show an alternative embodiment of the invention, according to which the locking member 42 is mounted to be tilting with respect to the plate 20 about an axis C which is substantially transversal, i.e. perpendicular to the main rotation axis B.

In addition, here, to obtain the locking of the sleeve 48 in rotation about the main axis B, the locking member 42 includes a mobile clamp 58 which includes two branches 60 between which the sleeve 38 is capable of being received when the locking member 42 is in the locking position thereof, as it can be seen in FIG. 5.

In addition, the sleeve 38 includes two axial faces 62, or flat sections, which are supplied in the external cylindrical face 38e of the sleeve 38, and which are radially opposite with respect to the main rotation axis B, and whereon the branches 60 of the clamp 58 are capable of bearing to lock the sleeve 38 in rotation.

The articulation of the locking member 42 with respect to the plate 20 is obtained through a base 64 which is fixed to the plate 20, and an articulation portion 66 associated with the locking member 42.

The locking member 42 includes a first arm 68 which extends substantially radially with respect to the transversal axis C from the articulation portion 66 of the locking member 42, and the free radial end 66a carries the locking clamp 58.

The locking member 42 also includes a second arm 70 which extends radially with respect to the transversal axis C, from the articulation portion 66, so that the locking member substantially has the shape of an inverted “V”, each branch of the “V” being formed by an arm 68, 70.

The free end 72 of the second arm 70 is folded transversally, i.e. parallel to the transversal axis C, and it is capable of bearing against the bearing element 44 of the motor reducer 26 to cause the locking member 42 to move towards the unlocking position thereof, as can be seen in FIG. 6.

Finally, the locking means 40 include a return elastic element (not shown) of the locking member 42 from the unlocking position thereof to the locking position thereof, as shown in FIG. 5.

The operation of the locking means 40 according to this embodiment of the invention is similar to the operation of the locking means according to the first embodiment of the invention, which has been previously described.

Thus, when the window panel 12 is in the raised open position, the free end 72 of the second arm 70 does not cooperate with the bearing element 44, the locking member 42 is in the locking position thereof, as shown in FIG. 5, i.e. each branch 60 of the clamp 58 cooperates with an axial face 62 of the sleeve 38.

During the motion of the window panel 12 from the open position thereof towards the closed position, the free end 72 of the second arm 70 comes in contact with the bearing element 44 when the window panel 12 is in an intermediate position, so that it cannot longitudinally move frontward beyond such position.

Further, upon the motion of the window panel 12 from such intermediate position, towards the locked position thereof, the bearing of the free end 72 of the second arm 70 on the bearing element 44, simultaneously with the motion of the window panel, causes the rotation of the locking member 42 from the locking position thereof up to the unlocking position thereof, as shown in FIG. 6.

Here, the bearing element consists of a longitudinal rod which extends rearwards from the motor reducer 26. Now, it should be understood that the invention is not limited to this embodiment, and that the bearing element 44 may have another shape, such as for example that of a disk mounted on the motor shaft 36, as previously described, while referring to FIG. 4.

According to the embodiment shown in FIG. 7, the drive shaft 22 of the wiper mechanism includes a crankshaft pin 75. The locking member 42 includes a mechanical stop 76 which is mounted to be slidingly movable with respect to the plate 20 according to a direction substantially parallel to the main axis B of the drive shaft 22 between a locking position, wherein the mechanical stop 76 is in contact with the crankshaft pin 75, to obtain the locking in rotation of the drive shaft 22 and an unlocking position. The mechanical stop 76 may be guided in guiding means 77 formed on the plate 20. Such guiding means 77 and the plate 20 may be cast in one piece. Such guiding means 77 are here in the form of grooves.

The locking member 42 includes a cylindrical rod 48 having a principal axis parallel to the main rotation axis B, which is received in a matching recess 50 of the plate 20 for the sliding guidance thereof. The mechanical stop 76 is mounted on the cylindrical rod 48 by means of a holding clamp 79.

An end of the crankshaft pin 75 is connected in a non-detachable way to the drive shaft 22. The other end includes a finger 78, intended to be connected to a plate (not shown), mounted on a motor shaft of a wiper motor. The connection between the finger 78 and the plate is shifted, but substantially parallel to the main axis B of the drive shaft 22.

The mechanical stop 76 and the crankshaft pin 75 have matching shapes. In the locking position, the mechanical shape 76 is in contact with one end of the crankshaft pin 75. The matching shapes of the end of the crankshaft pin 75 and the mechanical stop 76 prevent their being disconnected. For reasons of rigidity and reduction in weight, the mechanical stop 76 is made of aluminium or zamak. In the locking position, the drive shaft 22 is locked in a predetermined angular position, which consists in a position about the main rotation axis B, which corresponds to the rest position of the wiper mechanism.

1. A wiper mechanism for a motor vehicle including a window panel which is mounted to be pivoting between a closed position and at least an open position, the wiper mechanism comprising:
a plate for guiding in an alternate rotation a drive shaft about a main rotation axis;
a motor reducer which includes a motor shaft extending coaxially with the drive shaft; and
means for locking the drive shaft in rotation with respect to the plate in a predetermined angular position of the drive shaft,
wherein the locking means include a locking member which is mounted to be movable with respect to the plate between a locking position, in the open position of the window panel, wherein the locking member cooperates with the drive shaft in rotation with respect to the plate, and an unlocking position, in the closed position of the window panel, wherein the locking member does not cooperate with the drive shaft, allowing the rotation of the drive shaft with respect to the plate.

2. A wiper mechanism for a motor vehicle including a window panel which is mounted to be pivoting about an axis transversal with respect to a structural element of the vehicle body between a closed position, wherein the window panel substantially extends in a vertical and transversal plane, and at least an open position, wherein the window panel is inclined with respect to said vertical and transversal plane, wherein the wiper mechanism comprises:
a plate for guiding in an alternate rotation a drive shaft of a wiper arm with respect to the window panel about a main rotation axis, which is fixed in one opening of the window panel, so that the main rotation axis is oriented longitudinally, when the window panel is in the closed position,
a motor reducer which is fixed to the structural element of the body and which includes a motor shaft extending coaxially with the drive shaft when the window panel is in the closed position, and which is capable of being coupled in rotation with the drive shaft when the window panel is in the closed position, and
means for locking the drive shaft in rotation with respect to the plate in a predetermined angular position of the drive shaft, when the window panel is in the open position,
wherein the locking means include a locking member which is mounted to be movable with respect to the plate between a locking position, wherein the locking member cooperates with the drive shaft to lock the drive shaft in rotation with respect to the plate, when the window panel is in the open position, and an unlocking position, wherein the locking member does not cooperate with the drive shaft, thus allowing the rotation of the drive shaft with respect to the plate, when the window panel is in the closed position.

3. The wiper mechanism according to the preceding claim 2, wherein the drive shaft carries a sleeve for coupling the drive shaft with the motor shaft in rotation with respect to the plate which is integral with the drive shaft during the motion of the window panel with respect to the vehicle structural element of the body, and wherein the locking member is capable of cooperating with the drive shaft through the sleeve to reach the locking of the drive shaft in rotation with respect to the plate.

4. The wiper mechanism according to claim 2, wherein the locking member is mounted to be slidingly movable with respect to the plate according to a direction substantially parallel to the main axis of the drive shaft, between a front locking position and a rear unlocking position.

5. The wiper mechanism according to the preceding claim 3, wherein the sleeve includes a radial finger which is capable of abutting against an axial rod associated with the locking member.

6. The wiper mechanism according to claim 3, wherein the locking member includes a locking clamp which is movable substantially radially with respect to the main axis of the drive shaft and which is capable of cooperating with the sleeve for locking the drive shaft.

7. The wiper mechanism according to claim 6, wherein the locking member includes an arm which is mounted to be pivoting with respect to the plate about an axis perpendicular to the main axis of the drive shaft, and which carries the locking clamp.

8. The wiper mechanism according to claim 4, wherein the plate includes elastic means for returning the locking member to the locking position, and wherein the locking member is capable of cooperating with a bearing element which is mounted on the structural element of the body, so that a motion of the window panel towards the closed position results in the bearing of the locking member against the bearing element, then the motion of the locking member with respect to the plate towards the unlocking position, against the return elastic force.

9. The wiper mechanism according to claim 8, wherein the bearing element is a component of the motor reducer which is fixed to the structural element of the body.

10. The wiper mechanism according to claim 8, wherein the bearing element consists of a disk coaxial with the motor shaft which is integral with the motor shaft in rotation with respect to the structural element of the body.

11. The wiper mechanism according to claim 1, wherein the predetermined angular position is an extreme angular position of the drive shaft corresponding to a rest position of the wiper mechanism.

12. The wiper mechanism according to claim 1, wherein the drive shaft includes a crankshaft pin and in that the locking member includes a mechanical stop which is mounted to be slidingly movable with respect to the plate according to a direction substantially parallel to the main axis of the drive shaft between a locking position, wherein the mechanical stop is in contact with the crankshaft pin to obtain the locking in rotation of the drive shaft, and an unlocking position.

13. The wiper mechanism according to claim 12, wherein the mechanical stop and the crankshaft pin have matching shapes.
